(19) United States
(12) Patent Application Publication
(10) Pub. No.: US 2017/0045002 A1
(43) Pub. Date: Feb. 16, 2017

(54) Engine Air Shut-off Valve

(71) Applicants: Ming Fei Chen, Sugar Land, TX (US); Yanmei Li, Katy, TX (US)

(72) Inventors: Ming Fei Chen, Sugar Land, TX (US); Yanmei Li, Katy, TX (US)

(21) Appl. No.: 14/285,625

(22) Filed: May 22, 2014

(51) Int. Cl. F02D 17/04; F02D 9/10

(52) U.S. Cl. CPC F02D 17/04; F02D 9/1035; F02D 9/107; F02D 9/108

(57) ABSTRACT

An engine air shut-off valve consists of a housing, a gate pivotal about an axis that can open or close an air passage which extends through the housing, a locking piston attached to the housing that keeps the gate in open position and a closing piston assembly installed inside the housing that keeps the gate in close position when the air passage needs to be closed. Valve mounting flanges are attached to the housing through lock pins.

### CROSS-REFERENCE TO RELATED APPLICATIONS

Engine shut-off valves with reciprocating gates are known from U.S. Pat. No. 4,215,845, U.S. Pat. No. 4,546,954, U.S. Pat. No. 4,285,494, U.S. Pat. No. 4,501,238, U.S. Pat. No. 5,203,536, U.S. Pat. No. 5,205,252, and U.S. Pat. No. 6,273,053.

### BACKGROUND OF THE INVENTION

Engine air shut-off valves are used to prevent engine runaway over-speed caused by combustible gas or vapors through the engine air intake system. The most common method of engine shut-off is by terminating the air supply that provides oxygen to engine combustion. It is critical to have an air shut-off valve installed as a safety device that allows control over the operation of an engine as well as prolong the engine life.

### BRIEF SUMMARY OF THE INVENTION

In one aspect, embodiments disclosed herein relate to an engine air shut-off valve comprising a housing, a gate within the housing that is pivotal about an axis, an air flow passage extending through the housing and being parallel to the pivotal axis, a locking piston assembly containing a spindle when engaging with the gate through a latching feature in the first position wherein the air flow passage is open, the spindle disengaging from the gate in the second position wherein the air flow passage is closed, a closing piston assembly containing a compression spring acting between the gate and the housing to keep the gate in close position when the air flow needs to be cut off, valve mounting flanges attached to the housing through lock pins and connected to external engine air intake system.

This invention is an improvement in terms of ease of manufacturing, installation, operation, repair and maintenance as well as improved reliability.

### BRIEF DESCRIPTION OF THE SEVERAL VIEWS OF THE DRAWINGS

An embodiment of the invention will now be described by way of example only, with the use of drawings in which:

FIG. 1 is a sectional side view of the engine air shut-off valve according to the invention in open position;

FIG. 2 is a sectional side view of the engine air shut-off valve according to the invention in close position;

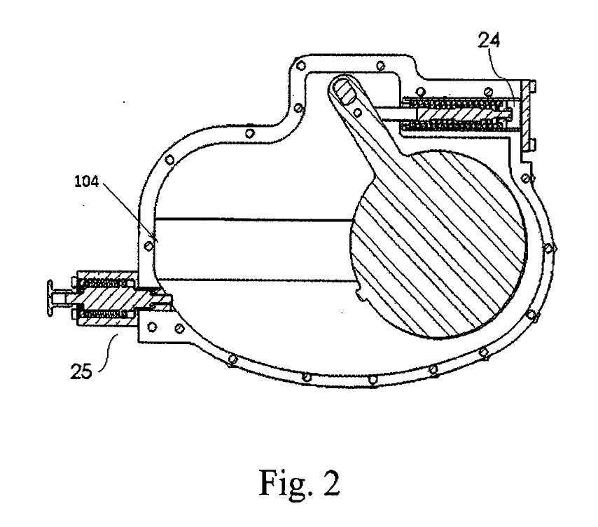

FIG. 3 is a cross sectional view of the engine air shut-off valve, that is perpendicular to FIG. 1;

FIG. 4 is side view of the engine air shut-off valve exterior.

FIG. 5 is a front view of the engine air shut-off valve exterior.

FIG. 6 is an isometric view of the engine air shut-off valve

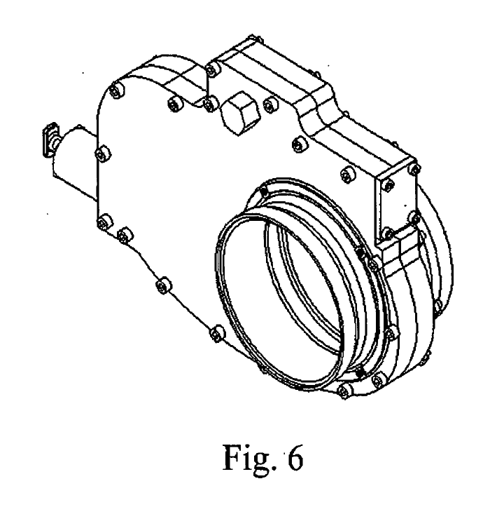

### DETAIL DESCRIPTION OF THE INVENTION

The shut-off valve 8 consists of housing 23, gate 26, closing piston assembly 24, and locking piston assembly 25.

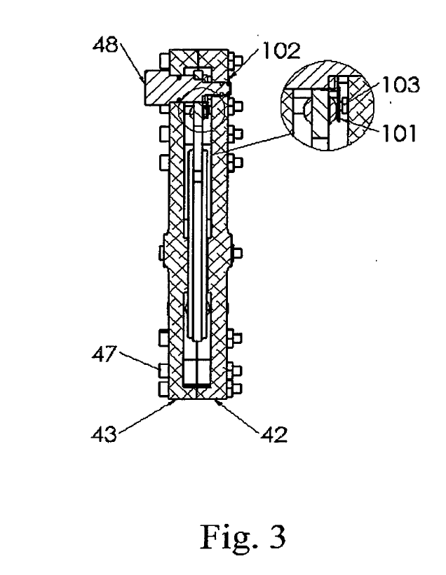

The housing 23 comprises two halves 42, 43 as viewed in FIG. 3. The partition of housing two halves is parallel to gate surface. This arrangement provides easy access to valve installation and maintenance. The two halves are connected by cap screws 47, aligned to form an unobstructed passageway 27 extending through, the axis 50 of which is parallel to the axis 52 about which gate 26 pivots.

Gate 26 is held in place about pivot axis 52 by a rotating lever 48 as shown in FIG. 3. Rotating lever 48 extends through housing 23, being retained by a snap ring 102 within the housing half 43 and rotates about axis 52. Gate 26 has a vulcanized rubber seal mounted on both sides that contact with air passage 27 in closed position. Gate 26 stays open or latched position via engaging with locking piston assembly 25 through gate latch 66. Gate 26 is connected with clevis 71 through pin 103.

The locking piston assembly 25 is attached to housing 23 externally by screws 69. This arrangement provides easy installation and connection to external control mechanism. The position of locking piston assembly 25 varies from Point A to Point B along the housing 23 contour. With change of location of locking piston assembly 25, the profiles of head portion 68 of spindle and gate latch 66 will change accordingly to ensure good engagement of these two.

Locking piston assembly 25 includes cylinder 67, spindle 61, pull handle 63, compression spring 64, wiper seal 60 mounted between spring 64 and cylinder 67 on the pull handle 63 side, and U-cup seal 65 mounted between cylinder 67 and spindle 61 through bushing 83 on the inner side of housing 23 cavity. The profile of head portion 68 of spindle 61 is complementary to the latch of gate 26. The locking piston assembly 25 is reciprocal along axis 82 to move in and out of the latch on gate 26 to adjust valve open or close position. Compression spring 64 exerts pressure on the piston assembly 25 to maintain spindle 61 engagement with gate 26 at latch 66.

The closing piston assembly 24 is contained within the housing 23. It includes sleeve stop 70, clevis 71, compression spring 72, spring sleeve 73 and retainer 74. The compression spring is locked through lock nut 75 and positioned through sleeve stop 70. The closing piston chamber is closed with end cap 77 using screws 76.

When gate 26 is disengaged from spindle 61 within locking piston assembly 25, gate 26 is pulled by a compression spring 72 in a closing piston assembly 24 to close the air passage 27. Gate 26 can be adjusted to open position by rotating the rotating lever 48 clockwise until the gate 26 is engaged with spindle 61 at latch 66. Gate aligns to the center of upper and lower housing cavities with extruded guiding surface 104.

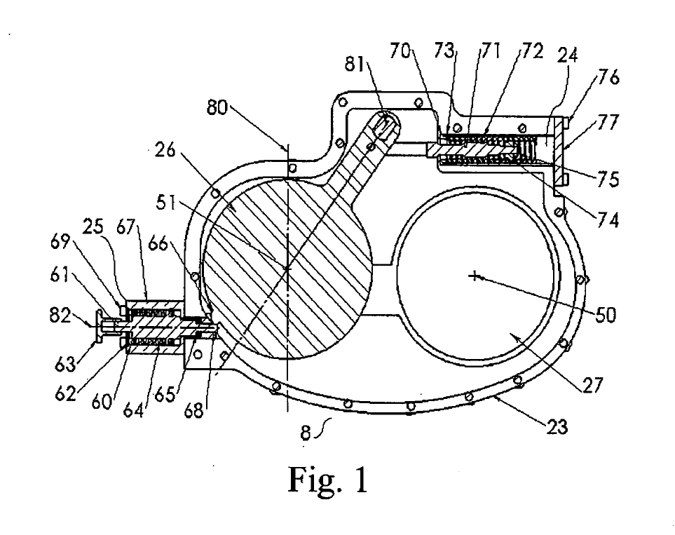

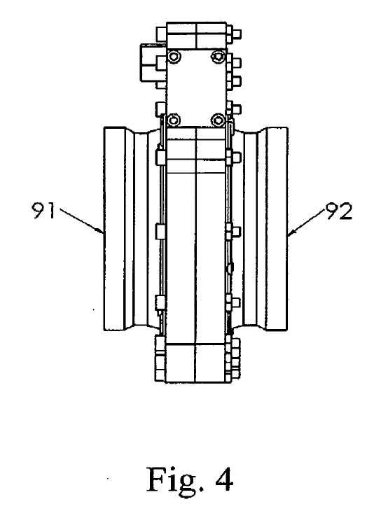

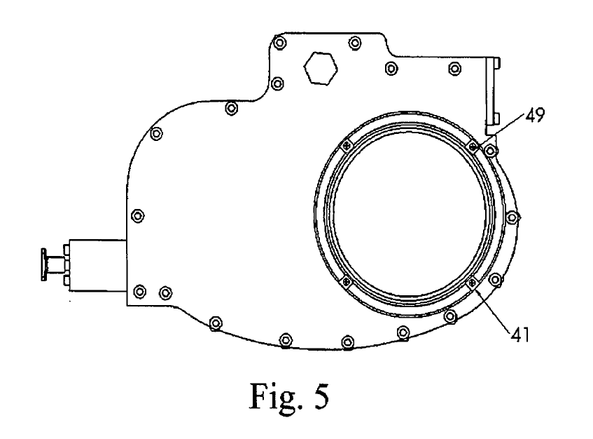

The engine shut-off valve 8 is installed at the air intake system of the engine through flange 91 and 92 connections as shown in FIG. 4. Flange 91 and 92 are attached to the housing 23 through lock pin 41 and set screw 49 as shown in FIG. 5. Flange 91 and 92 are designed to accommodate the installation requirements for the extensive variations of engine applications with variety of valve connection methods for engine air intake lines. The connection methods include hose, Marmon flange (V-clamp), seal ring slip fit, bolted flange, and additional custom connections. The engine air shut-off valve 8 is installed at the intake manifold of a diesel engine. When it is in operating condition, the air passage is unobstructed being positioned to be coaxial to the shut-off valve 8 to allow air flow through intake manifold. When engine runaway occurs or when the engine needs to be shut down by the operator, the gate 26 of shut-off valve 8 can be closed manually or using automatic control system via pulling the handle 63 to the left as viewed in FIG. 1 to disengage spindle head 68 from the gate latch 66. The gate 26 will rotate counter-clockwise about axis 52 with the pulling force of compression spring 72 and closing piston 24 to the closed position where air passage 27 is completely obstructed. This will terminate air flow through the engine to shut down the engine.

To reopen the air passage to supply air flow for engine operation, the rotating lever 48 can be rotated clockwise manually or using automatic control system until the gate latch 66 engages with the spindle head 68 by compressing the compression spring 64 inside the locking piston assembly 25. The air passageway 27 is now open and engine is ready for operation.

The compression spring 72 and spring sleeve 73 inside closing piston assembly 24, are accessible by the removal of end cap 77. The closing force of compression spring 72 can be adjusted by rotating lock nut 75 and therefore on clevis 71. The compression spring 64 inside locking piston assembly 25 is accessible by removal of snap ring 62 and wiper seal 60. The locking piston assembly 25 can be detached by removal of cap screw 69 for service.

Flange 91 and 92 are attached to housing 23 through lock pin 41 and set screw 49. This is secure and reversible assembly process, which enables the shut-off valve and flanges to be repaired or serviced separately, therefore reduces the cost of warranty and manufacturing scraps.

The drawings illustrate the manual method of locking piston assembly 25. The reciprocal adjustment can also be realized with electrical, pneumatic or hydraulic means. To do it more intelligently, valve open and close operation can be combined with sensor readings through oxygen concentration, hydrocarbon concentration, engine over-speed, chemical fume concentration, vibration, noise level etc. The valve is monitored with sensors so engine over-run can be closely monitored and controlled. Gate can be close when pre-set warning signals are activated. The valve is installed with sensors that are connected to control system to trigger gate open and close motion. The sensors can be accelerometer, noise sensor, chemical sensor, and temperature sensor.

1. An engine air shut-off valve consists of a housing, a gate pivotal about an axis that can open or close an air passage which extends through the housing, a locking piston attached to the housing that keeps the gate in open position and a closing piston assembly installed inside the housing that keeps the gate in close position when air intake needs to be shut off.

2. The engine air shut-off valve of claim 1, wherein the partition of the housing two halves is parallel to the gate surface.

3. The engine air shut-off valve of claim 2, wherein the locking piston assembly is attached to housing externally. The position of locking piston assembly Can vary along the housing contour.

4. The engine air shut-off valve of claim 3, wherein the locking piston assembly can be operated with electrical, pneumatic or hydraulic means.

5. The engine air shut-off valve of claim 2, wherein the closing piston assembly is contained within the housing.

6. The engine air shut-off valve of claim 5, wherein the closing piston can be operated with electrical, pneumatic or hydraulic means.

7. The engine air shut-off valve of claim 2, wherein the valve is equipped with sensors to monitor and control engine over-run. Gate can be closed when pre-set warning signals are activated.

8. The engine air shut-off valve of claim 7, wherein the valve is installed with sensors that are connected to control system to trigger gate open and close motion. The sensors can be accelerometer, noise sensor, chemical sensor, and temperature sensor. These sensors can be used together or separately.

9. The engine air shut-off valve of claim 2, wherein the flanges are attached to the housing through lock pins and set screws.
